(19) United States
(12) Patent Application Publication
(10) Pub. No.: US 2007/0038829 A1
(43) Pub. Date: Feb. 15, 2007

(54) Wait aware memory arbiter

(75) Inventor: Ivo Tousek, Stockholm (SE)

Correspondence Address: David I. Roche;BAKER & McKENZIE LLP, 130 E. Randolph Drive, Chicago, IL, 60601, US

(73) Assignee: VIA Technologies, Inc.

(21) Appl. No.: 11/202,708

(22) Filed: Aug. 11, 2005

(51) Int. Cl. G06F 13/00

(52) U.S. Cl. 711/167

(57) ABSTRACT

A memory arbiter in a processor system which can generate system level wait state to temporarily stop the clock to a processor is disclosed. The processor system comprises a memory, a processor, a memory arbiter and a clock controller. The memory arbiter generates a wait signal when the memory is not ready to service a memory request, and the clock controller selectively turns off a clock signal to the processor. In this way, the processor that cannot be waited by means of a dedicated wait input signal can be included in the arbitration scheme to improve the performance of the processor system.

### BACKGROUND OF THE INVENTION

1. Field of the Invention

This invention relates to data transfers in computer systems, and more particularly to a memory arbitration unit that utilize clock controlled wait states in a microprocessor system.

2. Description of the Related Art

Simple processors (microprocessor or digital signal processors) sometimes do not provide an external wait input signal. Such a wait signal is typically used by processor peripherals that are operating slower than the processor itself, when the peripheral needs to wait for the processor's access.

When such a non waiting processor is communicating with slower system peripherals which do not respond in a manner such that the processor can continue its execution, the peripherals cannot simply assert a wait signal back to the processor in order to temporarily wait for the processor's execution. Instead, techniques like polling or interrupt handling may be used.

When the non waiting processor issues a request to a slower system peripheral, the peripheral can either actively assert an interrupt request back to the processor as an indication that it is done with the processing of the request issued by the processor, or the processor can poll the peripheral for status. As an example, if the processor issues a read data request to a slower peripheral, an interrupt signal sent back to the processor, or a status flag inside the peripheral can be used as an indication that the processor now can read the requested data. Similarly, if the processor issues a write data request to a slower peripheral, an interrupt signal sent back to the processor, or a status flag inside the peripheral can be used as an indication that the write request has been processed and the processor now can issue further write requests to the peripheral.

Referring now to FIG. 1, there is illustrated a schematic diagram of a conventional processor system according to the prior art. The processor system includes a digital signal processing (DSP) processor 102, a memory 104, a memory arbiter 106 and system peripherals 108. The DSP processor 102, memory arbiter 106 and system peripherals 108 are coupled to a system bus 110. And the DSP processor 102, and system peripherals 108 can access the memory 104 through the memory arbiter 106 as shown in the Figure.

One question that arises in the above-mentioned system is how the memory arbiter 106 can perform any active memory arbitration among a number of memory requesting agents when the DSP processor issues a simultaneous request to the same physical memory, if the memory arbiter cannot tell the DSP processor to wait. In processing systems, it is typically not acceptable use interrupt handling or polling mechanisms to handle the processor's accesses to system memory.

Therefore, there is a need for an improved processor system structure which can offer a flexible and powerful platform by offering system level wait states.

### SUMMARY OF THE INVENTION

The present invention is directed to solving these and other disadvantages of the prior art. The present invention provides a memory arbiter in a processor system such as a digital signal processing (DSP) system that utilizes clock controlled wait states that temporarily stop the clock to the processor. In this way, the non waiting processor can be included in the arbitration scheme to improve the performance and conserve the power consumption of the processor system.

One aspect of the present invention contemplates a memory arbiter in a processor system such as a digital signal processing (DSP) system. The memory arbiter comprises an arbitration logic, a memory control unit and a wait generator. The wait generator generates a wait signal to a processor when a memory arbiter is not ready to service a memory request.

Another aspect of the present invention provides a processor system which comprises a memory, a processor, a memory arbiter and a clock controller. The memory arbiter generates a wait signal when the memory arbiter is not ready to service a memory request, and the clock controller selectively turns on/off a clock signal to the processor.

Yet another aspect of the present invention provides a memory arbitration method of a memory arbiter in a DSP system. The method comprises the steps of receiving a memory request from an agent of the processor system, asserting a wait signal by the memory arbiter to turn off a clock to the agent of the processor system when the memory arbiter can not service the memory request, and deasserting the wait signal to perform a data transfer when the memory request is ready to be serviced.

Yet another aspect of the present invention provides a memory arbitration method of a memory arbiter in a processor system. The method comprises the steps of receiving a memory request from a processor of the processor system, asserting a wait signal by the peripheral device to turn off a clock to the agent of the processor system when the memory arbiter can not service the memory request, and de-asserting the wait signal to perform a data transfer when the memory request is ready to be served.

### BRIEF DESCRIPTION OF THE DRAWINGS

The accompanying drawings are included to provide a further understanding of the present invention, and are incorporated in and constitute a part of the description to this invention. The drawings illustrate embodiments of the present invention, and together with the description, serve to explain the principles of the present invention. There is shown:

FIG. 1 illustrates a schematic diagram of a conventional processor system according to the prior art;

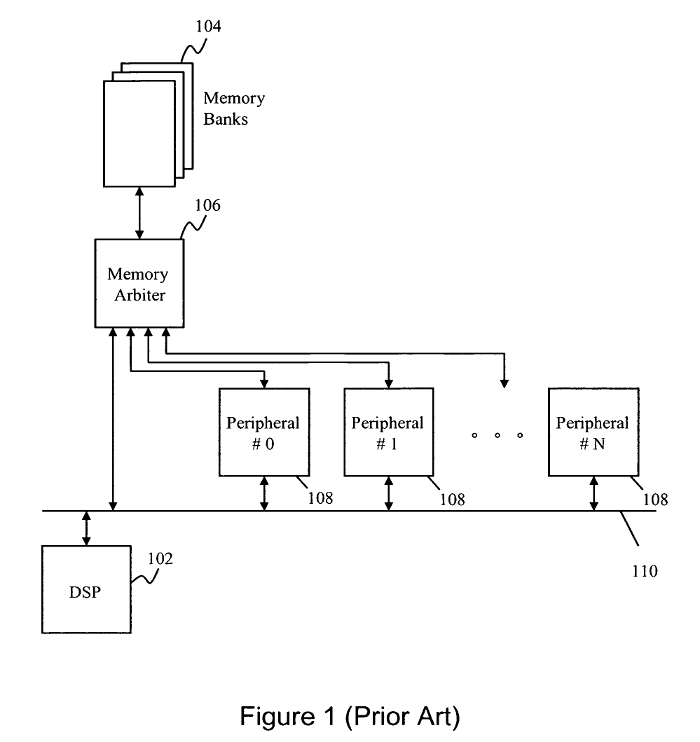

FIG. 2 illustrates a schematic diagram of a simple processor system according to a preferred embodiment of the present invention;

FIG. 3 illustrates a detailed block diagram representation of the preferred memory arbiter according to the present invention;

FIG. 4 illustrates a timing diagram showing two memory read requests issued consecutively by the processor according to a preferred embodiment of the present invention;

FIG. 5 illustrates a timing diagram showing two memory write requests issued consecutively by the processor according to a preferred embodiment of the present invention; and

FIG. 6 illustrates a schematic diagram of a simple processor system according to another preferred embodiment of the present invention.

### DESCRIPTION OF THE PREFERRED EMBODIMENTS

The invention disclosed herein is directed to a memory arbiter in a DSP system which can utilize system level wait state to stop the clock to a processor temporarily. In the following description, numerous details are set forth in order to provide a thorough understanding of the present invention. It will be appreciated by one skilled in the art that variations of these specific details are possible while still achieving the results of the present invention. In other instances, well-known backgrounds are not described in detail in order not to unnecessarily obscure the present invention.

One aspect of the present invention is to enable a memory arbiter to generate a wait signal when the memory is not ready to service a memory request. The wait signal triggers the clock controller to selectively turn off a clock signal to the processor. In this way, the non waiting processor can be included in the arbitration scheme to improve the system level performance. As an example, the processor and other system level units may all be part of a fixed priority or rotating priority memory access scheme, even though the processor does not provide a dedicated input wait signal. Furthermore, turning off the clock to the processor will reduce the power consumption in the processor system.

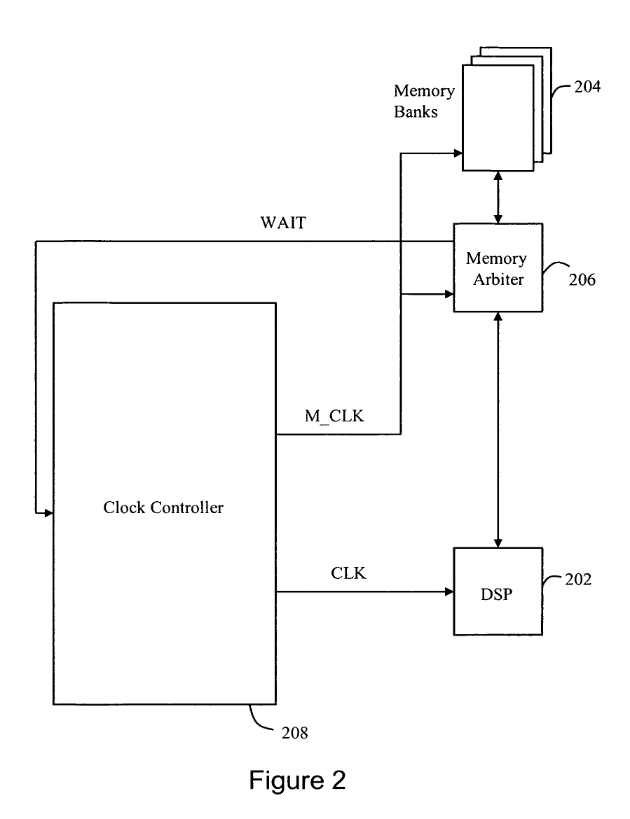

Referring now to FIG. 2, there is illustrated a schematic diagram of a simple processor system according to a preferred embodiment of the present invention. The processor system includes a processor 202, a memory 204, a memory arbiter 206 and a clock control unit 208. The processor 202 can access the memory 204 through the memory arbiter 206 as shown in the Figure. This embodiment utilizes clock controlled wait state WAIT on the system level. If the processor 202 issues a memory request to the memory arbiter 206 but the memory arbiter decides to grant another agent that is requesting the same physical memory at the same time, then the memory arbiter asserts a dedicated wait signal WAIT to the clock control unit 208 which will globally disable the clock to the processor 202. In one embodiment, the processor is a digital system processing (DSP) processor. Alternatively, other types of processors can also be used.

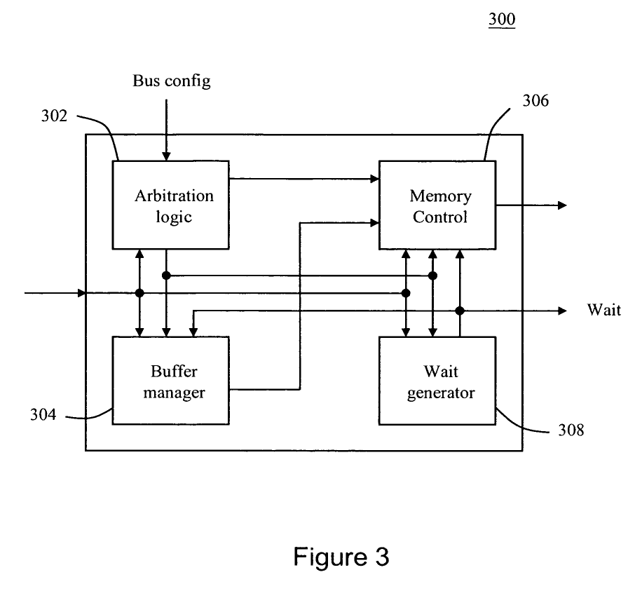

Referring now to FIG. 3, there is shown a detailed block diagram representation of the preferred memory arbiter according to the present invention. In one embodiment, the memory arbiter 300 comprises an arbitration logic 302, a buffer manager 304, a memory control 306 and a wait generator 308. The arbitration scheme which is configured by the processor over the system bus can be of either fixed priority or rotating priority. The arbitration logic 302 arbitrates among a number of active requests coming in and selects which agent to be serviced. The buffer manager 304 temperatorily holds the data when it is not ready to be serviced. The memory control 306 controls the data flows between the agents. The wait generator 308 generates a WAIT signal to the processor 202 when the memory is not ready to service the processor as mentioned before.

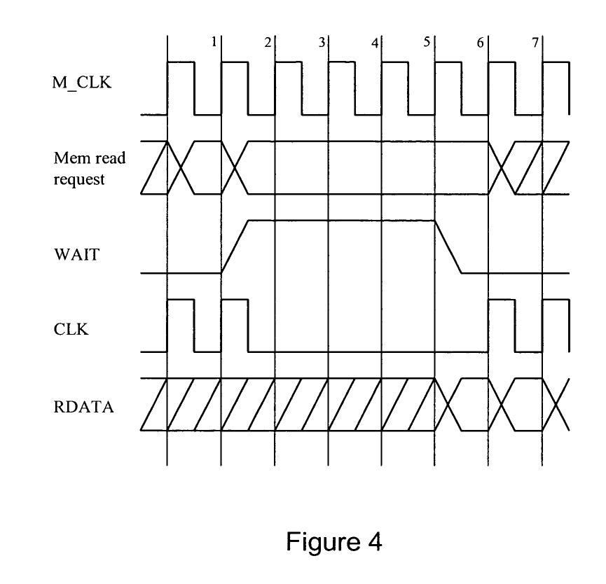

Referring now to FIG. 4, there is illustrated a timing diagram showing two memory read requests issued consecutively by the processor according to a preferred embodiment of the present invention. In the example, the M_CLK is the clock to the memory arbiter 206 and memory 204, CLK is the clock to the processor 202. The processor which issues a memory read request in cycle I is waited by the memory arbiter 206 during cycles 2-5. The memory arbiter 206 asserts a WAIT signal which disables the CLK clock out from the clock controller 208. When the memory arbiter decides to service the processor's memory read request, it de-asserts the WAIT signal and drives the read data to the processor 202 in cycle 6 which captures the data on the clock edge. The example also shows a second memory read request from the processor 202. This second request is stalled behind the first memory read request until it is serviced in cycle 6 and the associated read is driven back to the processor in cycle 7. The waited read request from cycle I is buffered internally in the memory arbiter peripheral until it is serviced, as it is taken off the processor's memory request bus in the next cycle.

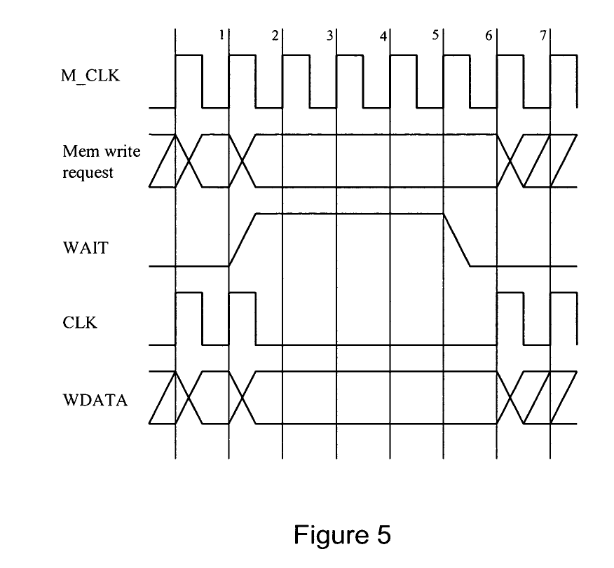

Referring now to FIG. 5, there is illustrated a timing diagram showing two memory write requests issued consecutively by the DSP processor according to a preferred embodiment of the present invention. In the example, the processor which issues a memory write request in cycle 1 is waited by the memory arbiter 206 during cycles 2-5, and the second write request is performed in cycle 6 without being waited by the memory arbiter 206. Similarly, the first memory write request and the associated write data has to be buffered internally in the memory arbiter until it is serviced, as it taken off the processor's memory request bus in the next cycle.

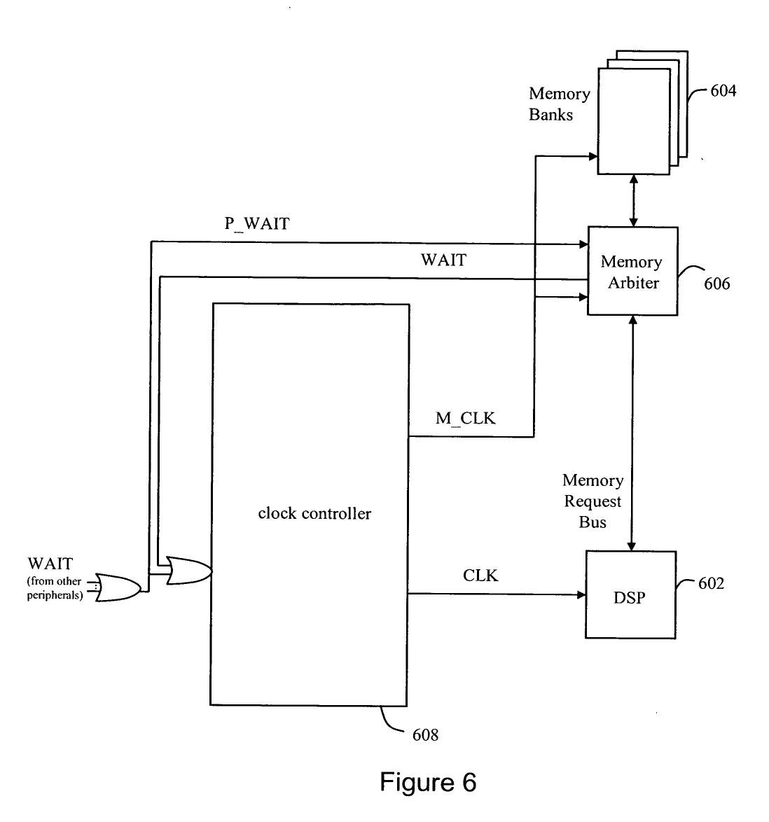

Referring now to FIG. 6, there is illustrated a schematic diagram of a simple processor system according to another preferred embodiment of the present invention. The processor system includes a processor 602, a memory 604, a memory arbiter 606 and a clock control unit 608. The processor 602 can access the memory 604 through the memory arbiter 606 as shown in the Figure. This embodiment not only utilizes clock controlled wait states inserted by the memory arbiter as described before but system peripherals connected to the processor's Memory Request bus can also insert wait states by driving their own wait signal, respectively. All wait signals can be Ored together in the clock controller to provide a global P_WAIT signal which is then driven to all peripherals and the memory arbiter. Internally in the clock controller the P_WAIT signal is used to control the on/off state of the clock to the processor. Externally, it is used to invalidate all processor's accesses over the Memory Request Bus while the P_WAIT signal is active.

Now referring to FIG. 5 again, if a processor access to a peripheral in cycle 1 is being waited by the peripheral in cycles 2-5 as indicated by an active level on the P_WAIT signal, a processor access to memory through the memory arbiter in cycle 2 can be considered as invalid by the memory arbiter throughout cycles 2-5, during which time the memory arbiter may grant other unit access to memory, hereby increasing memory access performance in the system. The memory arbiter may then grant the memory access to the processor in cycle 6, or the memory arbiter may now wait the processor access in cycle 6 by raising its wait signal in cycle 7.

One may note that without wait awareness in the memory arbiter, the system would still work. The wait awareness allows more memory bandwidth for memory requesting agents according to the present invention.

Finally, those skilled in the art would appreciate that they can readily use the disclosed conception and specific embodiments as a basis for designing or modifying other structures for carrying out the same purpose of the present invention without departing from the spirit and scope of the present invention as defined by the appended claims.

What is claimed is:

1. A memory arbiter, comprising:
an arbitration logic;
a memory control; and
a wait generator for generating a wait signal to a processor when a memory is not ready to service a memory request.

2. The memory arbiter according to claim 1, further comprising a buffer manager.

3. The memory arbiter according to claim 1, wherein said arbitration logic uses a fixed priority arbitration scheme.

4. The memory arbiter according to claim 1, wherein said arbitration logic uses a rotating priority arbitration scheme.

5. A processor system, comprising:
a memory;
a processor;
a memory arbiter to generate a wait signal when the memory arbiter is not ready to service a memory request; and
a clock controller to selectively turn-on or turn-off a clock signal to the processor.

6. The processor system according to claim 5, wherein said processor is a wait unknowledgeable processor.

7. The processor system according to claim 5, wherein said memory arbiter, comprising:
an arbitration logic;
a memory control unit; and
a wait generator.

8. The processor system according to claim 7, further comprising a buffer manager.

9. The processor system according to claim 5, wherein said memory arbiter uses a fixed priority arbitration scheme.

10. The processor system according to claim 5, wherein said memory arbiter uses a rotating priority arbitration scheme.

11. The processor system according to claim 5, wherein said clock controller turns off the clock signal to the processor based on the wait signal generated by the memory arbiter.

12. The processor system according to claim 5, wherein said clock controller drives two different clock signals to the processor and the memory arbiter, respectively.

13. The processor system according to claim 5, further comprising at least one peripheral device.

14. The processor system according to claim 13, wherein said peripheral device generates a second wait signal to selectively turn-off the clock signal to the processor.

15. The processor system according to claim 13, wherein said peripheral device generates a second wait signal to the memory arbiter to invalidate any memory request from the processor.

16. A memory arbitration method of a memory arbiter in a processor system, comprising:
receiving a memory request from an agent of the processor system;
asserting a wait signal by the memory arbiter to turn off a clock to the agent of the processor system when the memory arbiter can not service the memory request;
deasserting the wait signal to perform a data transfer when the memory request is ready to be serviced.

17. The method according to claim 16, wherein said agent is a processor.

18. The method according to claim 17, wherein said processor is a wait unknowledgable processor.

19. A memory arbitration method of a memory arbiter in a processor system, comprising:
receiving a memory request from a first agent of the processor system;
asserting a wait signal by a second agent to turn off the clock to the first agent of the processor system when the memory arbiter can not service the memory request;
deasserting the wait signal to perform a data transfer when the memory request is ready to be serviced.

20. The method according to claim 19, wherein said first agent is a processor.

21. The method according to claim 20, wherein said processor is a wait unknowledgable processor.

22. The method according to claim 19, wherein said second agent is a peripheral device.
